(19) United States
(12) Patent Application Publication
(10) Pub. No.: US 2026/0036972 A1
(43) Pub. Date: Feb. 5, 2026

(54) PALLETIZING DEVICE AND OPERATING METHOD

(71) Applicant: AVENTUS GMBH & CO. KG, Warendorf (DE)

(72) Inventors: Rüdiger GROSSE-HEITMEYER, Westerkappeln (DE); Stephan HOLWITT, Telgte (DE); Markus RYCHLIK, Hamm Westf (DE)

(21) Appl. No.: 19/099,943

(22) PCT Filed: Jul. 26, 2023
(86) PCT No.: PCT/EP2023/070684

§ 371 Date: Jan. 30, 2025

(30) Foreign Application Priority Data
Aug. 2, 2022 (DE) 10 2022 119 394.2

(51) Int. Cl. G05B 19/418; B65G 47/244; B65G 57/11

(52) U.S. Cl. CPC G05B 19/4189; B65G 47/244; B65G 57/11; B65G 2811/0673; G05B 2219/50368

(57) ABSTRACT

A method for operating a palletizing device for palletizing piece goods, is suitable for operating a palletizing device including at least one control device and at least one display device, wherein it is displayed to a user on the display device in the response to a stop of the palletizing device, which piece goods may/must be removed from the process and/or which piece goods may/must not be removed from the process. The palletizing device for palletizing piece goods includes a conveying device with a conveying element for conveying piece goods and a depositing table, wherein the conveying device includes a rotating device for rotating the piece goods. A control device and a display device are furthermore provided, wherein the control device is suitable and formed to carry out the above-described method.

### DESCRIPTION

The present invention relates to a method for operating a palletizing device for palletizing piece goods, in particular of bags, preferably of bags filled with piece goods, after an unplanned stop, such as, e.g., in the case of defective bags or an emergency stop. The palletizing device, which is operated, comprises at least one conveying device with at least one conveying element for conveying piece goods and at least one depositing table, and the conveying device comprises at least one rotating device for rotating the piece goods. The palletizing device furthermore has at least one control device and at least one display device. The present invention additionally relates to a palletizing device for palletizing piece goods, in particular of bags, preferably of bags filled with piece goods, wherein the palletizing device comprises at least one conveying device with at least one conveying element for conveying piece goods and at least one depositing table. The conveying device comprises at least one rotating device for rotating the piece goods. The palletizing device furthermore has at least one control device and at least one display device.

A so-called palletizer is often connected downstream from, for example, packaging facilities for filling piece goods into bags, which pelletizer stacks the filled bags on pallets in bag layers with respectively offset layer patterns or transfers them onto a sheet or also into a stack in a pallet-free manner. An optimal further transport of the filled bags or also of other piece goods, depending on the facility, can thus be ensured.

In order to palletize filled bags, a certain bag layer of a certain number of bags in a certain arrangement to one another, thus with a certain layer pattern, is arranged on a so-called depositing table and is subsequently deposited on a pallet located therebelow, e.g., by pulling away the depositing table.

Depending on the configuration of the palletizer, the bags are conveyed, for this purpose, to the depositing table via conveyor belts, wherein the bags are aligned either longitudinally or transversely, depending on the position in the corresponding bag layer and depending on the layer pattern, for example by means of clamping/rotating devices. For example, a first row of a layer can thus comprise two bags in the longitudinal alignment and a second row with three bags in the transverse alignment. The next layer is then arranged the other way around, so that the layers are stacked in combination.

So that the automatic and stable stacking works reliably, the correct alignment of the bags along the conveyor line is essential. It is problematic if an error occurs or if a bag breaks during the transport or if a defect of the bag is recognized on the way to the depositing table. An unplanned stop then happens.

In order to restart the pelletizer, a user has to, e.g., look for and remove the defective bag. If only the bag was removed, the layer pattern may possibly not be maintained, depending on the position of the bag. However, it is often relatively difficult for the user to recognize whether or not he can, e.g., simply remove a defective bag.

In the event of an unplanned stop or in the event of an emergency stop, bags are generally possibly partly in a non-defined state.

The palletizer must not simply be restarted in such a situation but it must be checked whether all bags are present at a predetermined position in a predetermined orientation. Should this not be the case, a user has to intervene. However, the control is partly highly costly and complex.

It is thus the object of the present invention to support a user of a palletizing device when operating the palletizing device, so that the operation can be continued efficiently and in particular in an error-free manner, in particular after an unplanned stop of the facility.

This object is solved by means of a method for operating a palletizing device with the features of claim 1 and by means of a palletizing device with the features of claim 15. Preferred further developments of the invention are subject matter of the subclaims. Further advantages and features of the present inventions follow from the general description and the description of the exemplary embodiment.

The method according to the invention is suitable for operating a palletizing device for palletizing piece goods, in particular for palletizing bags. In particular bags filled with piece goods can thereby be palletized by such a palletizing device, which can then be operated according to the method according to the invention. The method according to the invention is thereby carried out after a stop of the palletizing device, in particular after an unplanned stop or an emergency stop, respectively, wherein the palletizing device comprises at least one conveying device with at least one conveying element for conveying piece goods and at least one depositing table. The conveying device comprises at least one rotating device for rotating the piece goods, or at least one rotating device for rotating the piece goods is assigned to the conveying device, respectively. The palletizing device furthermore comprises at least one control device and at least one display device. According to the invention, it is displayed to a user on the display device in the response to a stop of the palletizing device, in particular after an unplanned stop or an emergency stop, respectively, which piece goods may or must be removed from the process, respectively, and/or which piece goods may or must not be removed from the process, respectively.

An unplanned stop or an emergency stop, respectively, thereby in particular takes place, e.g., when piece goods are oriented incorrectly or are defective or, for example, also when an external emergency stop is triggered, for example by means of the actuation of a safety device.

The operating method according to the invention is in particular a method for restarting the palletizing device after an unplanned stop or emergency stop, respectively, in particular when a defective bag is present or if an error occurs.

The method for operating a palletizing device can in particular also be used in the case of palletizing devices, which have one or several rotating devices. The rotating devices are provided for suitably aligning the orientation of piece goods or of a bag, respectively, according to a predetermined layer pattern, thus longitudinally or transversely.

Further conveyor belts or intermediate belts, respectively, or collecting belts, respectively, and the like are preferably also provided, for example in order to arrange bags arriving from a packaging facility to form a certain layer pattern, which bags are subsequently pushed off onto a pallet or onto a bag layer, respectively, which was pushed onto the pallet beforehand.

For this purpose, a depositing surface for depositing at least one row of a layer or for depositing an entire layer, respectively, which is then subsequently pushed off as a whole, is provided in particular between a collecting belt and the depositing table.

The method according to the invention offers many advantages. In response to an unplanned or planned stop, respectively, or an emergency stop, a defective bag is generally contained on the conveyor line for forming the layer pattern or an error has occurred, so that a bag was inadvertently rotated in the wrong orientation by the rotating devices. So that a user or an operator of the palletizing device, respectively, can recognize quickly and easily where the error lies or which bag is faulty, respectively, and what is necessary as the next action for restarting the palletizing device, the faulty bag is displayed on the display device, so that said faulty bag can be removed from the process by hand, semi-automatically and/or also automatically.

Even if in the event of an unplanned stop or in the event of an emergency stop, bags are in a non-defined state, it can be displayed to a user in a simple manner, how he has to treat certain bags or whether or not he may simply remove bags, respectively. The palletizer must not simply be restarted in such a situation but it must be checked whether all bags are present at a predetermined position in a predetermined orientation. Should this not be the case, a user has to intervene. However, the control is partly highly costly and complex.

The display of the bags is provided by means of the control device, which evaluates the bags on the facility according to the layer pattern to be generated and which displays via the display device, which action can/may be/must be and which action cannot/may not/must not be performed, so as not to prevent the restart of the palletizing process or to provide for the restart, respectively.

A user can thus see directly, e.g., whether or not be may remove individual defective bags. A particularly efficient operation or restart, respectively, of the palletizing device can thus be ensured.

Depending on the position of a broken bag, it may no longer be possible to maintain or generate, respectively, the provided layer image any longer when removing said broken bag if the latter was removed. It can thus in particular also be provided that in addition to the removal of only a broken bag, a further bag or also further bags have to be removed or a certain position must be filled up again with a bag in a certain orientation.

The danger that an image pattern cannot be created any longer and thus a renewed stop of the facility becomes necessary, is significantly reduced or even eliminated by means of the method according to the invention. Above all, a user can generally put the facility into operation again significantly more quickly.

The piece goods currently located on the palletizing device is preferably displayed graphically to the user. An overview of the palletizing device is in particular shown in a schematic illustration, so that the user recognizes bags or piece goods, respectively, in particular as symbol and/or box or the like, on the schematic illustration, as they are currently present on the palletizing device or the conveyor line, respectively.

Depending on whether or not they may be removed from the process, the piece goods are particularly preferably displayed at least with a different property, which can be displayed. In particular graphic properties are preferred thereby. For example, a differentiation can be made via the color, a hatching, a border, a highlighting, a placement in the background and/or a text or the piece goods can also be highlighted differently. A group formation can in particular be displayed, so that it can be recognized clearly, which bags have to remain connected and which do not.

In expedient configurations, the piece goods are identified according to a predetermined later position in the layer stack or in the layer pattern, respectively. The bags can thereby in particular be displayed in a numbered or coded manner, respectively, so that a user recognizes quickly, which position the bag will take up in a later layer. A bag can, for example, be coded or numbered, respectively, with three digits, for example depending on the layer pattern, which is to be created, wherein the 3 digits specify the layer, the row and the bag. For example, a bag can thus be referred to as 5.2.4, wherein this bag is provided in the 5^{th} layer, in the 2^{nd} row of the layer and wherein the bag is the 4^{th} bag of the layer pattern in a consecutive numbering of the layer.

In expedient configurations, a user deletes at least one piece of piece goods in the display device, wherein the control device adapts the processing of the subsequent piece goods accordingly.

To delete piece goods, the user preferably marks the corresponding piece goods and then deletes the latter, for example, via a corresponding symbol and/or by shifting the bag or the symbol of the bag, respectively, into the trash can. It is thus possible, e.g., that a user touches a bag on a touch display and pulls the symbol onto a trash can symbol. Subsequently, the piece goods are in fact removed from the process, so that the actual state of the palletizing device then corresponds to the processed display again. The processing is then automatically adapted by the controller or the control device, respectively. For example, the numbering of the bags can then also be created or adapted again, respectively.

In expedient configurations, a warning is output when piece goods, which must not be removed from the process, are to be deleted. An operating error, which would partly interfere significantly with the subsequent processing process of the palletizing device, can thus be pointed out clearly to a user. This is so because depending on the layer pattern to be created, it is not possible to maintain the corresponding orientation of the bags when wrong bags are removed from the infeed or from the conveyor line, respectively.

The piece goods deleted by a user in the control device is preferably removed manually, semi-automatically and/or automatically from the process. A manual removal can take place by hand thereby, for example, so that a bag is removed from the belt by a user. A semi-automated removal can take place, for example, via a pusher, which pushes the piece goods from the conveyor belt or out of the conveyor line, respectively. The bag simply falls onto the floor next to the conveyor line, for example, and must be removed by a user by hand at some point. An automatic removal of piece goods can take place, for example, by means of a robot or also by means of a pusher, wherein the robot could then also feed a new bag at the corresponding position. A robot or also the pusher can preferably feed a defective bag to a different conveyor belt or the like for removal purposes, depending on the configuration.

In advantageous further developments, the palletizing device is divided into different stations, wherein the handling of the piece goods or of the bags, respectively, of the individual stations is evaluated and/or displayed separately by the control device. A particularly clearly structured display of the bags and of the possible or necessary approach, respectively, can thus be displayed, wherein a particularly efficient method is also made possible hereby.

Particularly preferably, several bags are displayed so as to be combined to form a group, which have to be treated equally. It might then be possible to remove or to delete the entire group, respectively, or to leave it on the conveyor line.

In expedient further developments, a user deletes at least one group of piece goods in the display device, in particular after he has marked it, wherein the control device adapts the processing of subsequent bags accordingly.

The planned layer patterns for the currently processed piece goods or the bags, which are currently located on the conveyor line, respectively, are preferably displayed. A user can thus control easily whether or not the approach specified by the control device is correct. He can additionally recognize and check quickly, how he must place a replacement bag.

At least one control device is preferably provided, which is suitable and formed to check the orientation and/or the state of the piece goods. Such a control device can in particular comprise at least one sensor, for example a light barrier, radar, a camera with corresponding image processing and/or ultrasound. The orientation can take place, for example, via an image analysis or by means of a light barrier for the duration of the activation. A bag aligned transversely blocks the light barrier for a shorter period of time than a longitudinally aligned bag. The state can in particular be the integrity of a bag, wherein in particular a checking for defects takes place here.

In expedient configurations, the control device checks after a removal of piece goods, whether the deletion of piece goods corresponds to the removal of piece goods and whether piece goods fed as a substitute have been placed in the correct orientation. Errors can thus be prevented, for example when a user selects and deletes the correct bag in the display device, but inadvertently removes the wrong bag from a conveyor belt or places a new bag in a wrong orientation.

The palletizing device according to the invention is suitable for palletizing piece goods, in particular of bags, in particular after an unplanned stop or emergency stop, respectively. The palletizing device has at least one conveying device with at least one conveying element for conveying piece goods and at least one depositing table, wherein the conveying device comprises at least one rotating device for rotating the piece goods or wherein at least one rotating device for rotating the piece goods is assigned to the conveying device, respectively. The palletizing device furthermore comprises at least one control device and at least one display device. According to the invention, the control device is suitable and formed to carry out the method as it has been described above.

The palletizing device according to the invention also offers the advantages, as they have already been specified above with regard to the method according to the invention.

The display device preferably comprises at least one touch display. By using a touch display, users can mark individual bags particularly easily and intuitively and can remove them from the process, so that the palletizing device can be restarted. Bags can thus be touched with the finger on the touch display and can be pulled onto a trash can symbol, e.g., for deletion purposes.

At least one handling device for removing piece goods or bags, respectively, is preferably provided. Such a handling device can preferably comprise at least one robot and/or at least one pusher, in order to remove piece goods or a bag, respectively, from a conveying element.

Further advantages and features of the present invention follow from the exemplary embodiment, which will be explained below with reference to the enclosed figures.

In the figures:

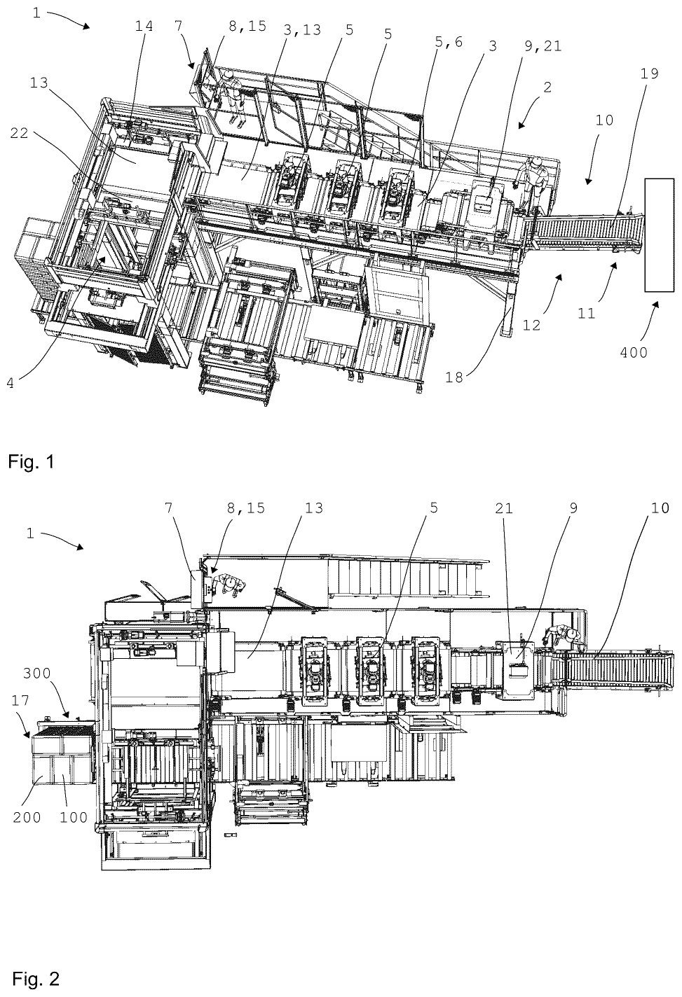

FIG. 1 shows a purely schematic illustration of an exemplary embodiment of a palletizing device according to the invention in a perspective view;

FIG. 2 shows a purely schematic illustration of an exemplary embodiment of a palletizing device according to the invention in a top view;

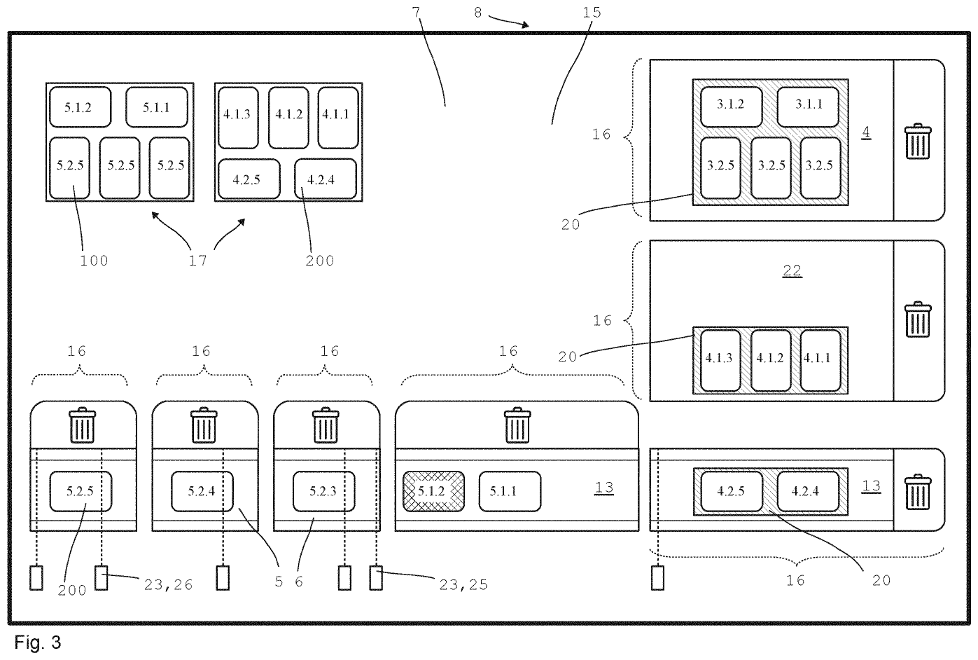

FIG. 3 shows a purely schematic illustration of a display on the display device of an exemplary embodiment of a palletizing device according to the invention; and

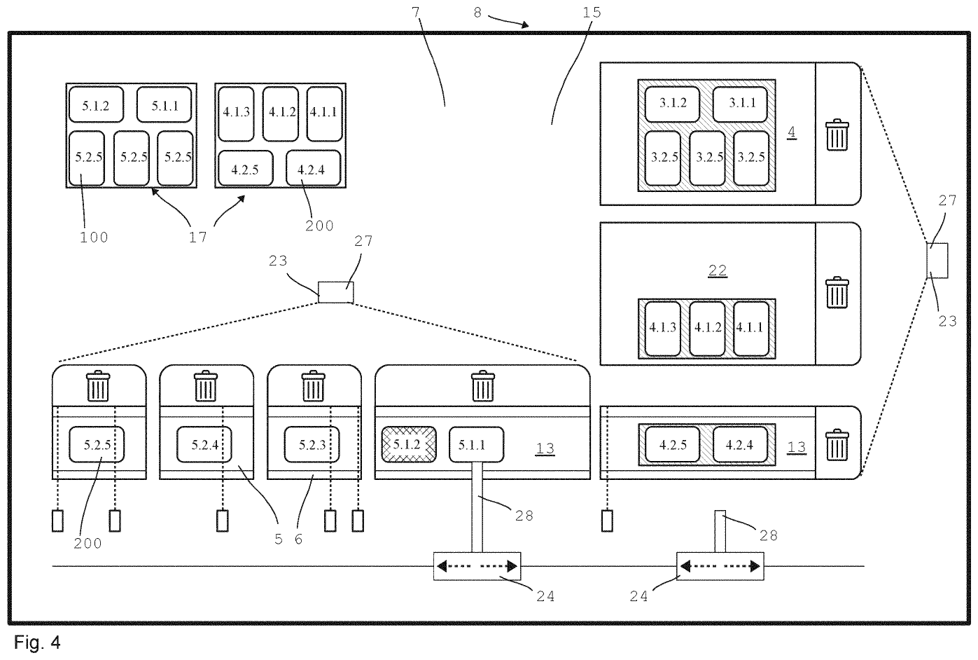

FIG. 4 shows a purely schematic illustration of a further display on the display device of an exemplary embodiment of a palletizing device according to the invention.

An exemplary embodiment of a palletizing device 1 according to the invention is illustrated in a purely schematic manner in a perspective view and a top view in FIGS. 1 and 2.

The palletizing device 1 according to the invention is in particular suitable to arrange piece goods 100 and, in the exemplary embodiment shown here, bags 200, in a predetermined layer pattern 17 and to transfer them onto a pallet 300, a sheet or also in a pallet-free manner.

In the exemplary embodiment shown here, bags are thereby filled and closed in a packaging facility 400, which is only suggested schematically and are then fed to the palletizing device 1 via an infeed 10.

A raised infeed situation 12 is thereby provided in the exemplary embodiment shown here, wherein even the entire palletizing device 1 is formed in a raised manner here. For this purpose, the components necessary for forming the layer pattern 17 of bags 200 are arranged in a raised manner on a type of stud frame 18.

In the exemplary embodiment shown here, the infeed 10 comprises an infeed buffer 11, so that a continuous and constant feeding of piece goods 100 or bags 200, respectively, to the palletizing device 1 can be attained via the length of the infeed 10 and the transport speed of the infeed 10. In the exemplary embodiment shown here, the infeed buffer 11 thereby comprises several gravity rollers 19.

Downstream from the infeed 10, the bags 200 are fed to a conveying device 2, which, in the exemplary embodiment shown here, has a conveying element 3, which is formed as conveyor belt 20 here.

The bags 200 to be palletized are initially fed via this conveyor belt 20 to a forming device 9, which is formed as so-called ironing and smoothing belt 21 here. In particular piece goods 100, which are not dimensionally stable, such as, for example, filled bags 200 are processed in this optional forming device 9 in such a way that contours, which are as even as possible and surfaces, which are as flat as possible, are present. A particularly even layer pattern 17 is attained hereby, so that the piece goods 100 or the bags 200, respectively, can be stacked in a particularly stable manner.

In the exemplary embodiment shown here, the conveying device 2 furthermore comprises three rotating devices 5, all of which are formed as clamping and rotating stations 6 in the exemplary embodiment shown here.

A respective bag 200, which can then be gripped and rotated if necessary, can be fed to each of these rotating devices 5 here. It thus becomes possible to arranged piece goods 100 or bags 200, respectively, on the conveying device 2 according to a layer pattern 17, which is to be manufactured. In the exemplary embodiment shown here, the layer pattern 17 is thereby prepared line-by-line in two lines.

In the exemplary embodiment shown here, a collecting belt 13 is connected downstream from the rotating devices 5, via which collecting belt the bags 200 brought into the desired orientation are conveyed line-by-line here in the direction of a depositing table 4.

In the exemplary embodiment shown here, the bags 200, which are suitably oriented for a layer pattern 17, or the individual lines for a layer pattern 17, respectively, are thereby initially fed to an intermediate storage 22. For this purpose, a pushing device 14 is furthermore provided, which initially pushes the first layer into an intermediate position and subsequently feeds the complete layer pattern 17, thus both lines, to the depositing table 4.

For example, a group of 5 can thus be placed, in the case of which two bags 200 are provided in the longitudinal orientation and three bags 200 in the transverse alignment, wherein a bag is optionally rotated by 180° in the longitudinal orientation, so that either the head or the foot side of the bags always points outwards. A first line of the layer pattern 17 is then oriented by means of the rotating devices 5 and is subsequently transported by means of the collecting belt 13 to the intermediate storage 22, wherein the pushing device 14 initially pushes it into an intermediate position The completely assembled layer pattern 17 or the complete layer of bags 200, respectively, is subsequently fed to the depositing table 4 by means of the pushing device 14.

In other configurations, the individual lines can also be fed separately to the depositing table 4 and can thus be assembled to form a complete layer pattern 17 only on the depositing table 4.

Depending on the configuration, the pushing device can comprise one or several pushers. A double pusher or a multiple pusher can thereby in particular also be provided.

The depositing table 4 can subsequently be displaced or pulled away, respectively, so that the layer of bags 200 is deposited on a palette 300 located therebelow or is transferred to the latter, respectively, in the figures. The depositing table 4 is in each case shown in the retracted position, in which the lead-through to the palette 300 is free. However, the layer pattern can also be transferred to a sheet or also in a pallet-free manner.

Due to the fact that a raised setup of the palletizing device 1 is provided, a pallet 300 can be arranged below the depositing table 4 here, wherein, the pallet 300 can be provided relatively close below the depositing table 4, for example by means of a corresponding system, for example by means of a roller conveyor, which can be raised and lowered. After a layer of bags 200 has been transferred to the pallet 300, the pallet 300 with the bags 200 can then be moved further downwards, so that the same distance from the depositing table 4 is present for the next layer of bags 200.

The layers are first formed twice lengthwise and three times crosswise and, in the case of the next layer, first three times crosswise and twice lengthwise, in each case alternately, e.g., in the case of a group of 5, in order to obtain an interlinked layer pattern, which contributes to an increased stacking and thus transport stability. Alternatively, the depositing surface or pallet, respectively, can also be rotated by 180° after each identically formed layer, in order to obtain the interlinked layer pattern.

A displayed diagram on the display device 8 of an exemplary embodiment of a palletizing device 1 according to the invention is illustrated purely schematically in FIG. 3, wherein the displayed view has been provided by means of the control device 7.

It can be seen in the shown view that the bags 200 of the two layers, which are currently processed, are illustrated purely schematically as symbols on the top left on the display device 8, wherein the respective layer patterns 17 are displayed purely schematically.

In order to give a user a particularly good overview, the individual bags 200 of the individual layers or layer patterns 15, respectively, are numbered consecutively. The first number thereby specifies the layer, the second number specifies the row in the layer and the third number specifies the consecutive numbering of the bags 200 in the layer. The bag of the layer, which is conveyed first, is thereby numbered with number 1, and all subsequent bags are numbered consecutively to 5 in the exemplary embodiment shown here.

In addition to the layer patterns 17, the palletizing device 1 is also illustrated purely schematically on the display device 8, wherein a division into individual stations 16 has been made here for a clearer overview.

The three rotating stations provided here, which are formed as clamping and rotating station 6 here, can be recognized. In the shown view, a bag is present in each rotating station 5, which bag is numbered consecutively according to its position in the corresponding layer pattern 17, as in the top left in the overview of the layer patterns 17. A user can thus clearly assign a bag 200 on the conveying device 2 or at a different point of the palletizing device 1 to the later position in a certain layer.

As can be recognized above in the overview of the layer pattern for layer 5, the three rotating devices 5 have to rotate the bags 5.2.5, 5.2.4 and 5.2.3 transversely one more time, in order to provide them on the conveying device 2 according to the orientation in the layer pattern 17.

Depending on the configuration, the rotating stations 5 can be treated as one station 16. However, each rotating station 5 is considered to be a separate station 16 here.

The next station 16 shows the collecting belt 13, which, in the exemplary embodiment shown here, conveys the bags 200 next to the intermediate storage 22, on which the complete layer pattern 17 is assembled before it is conveyed onto the depositing table 4. In the display, it can be seen in the case of the station 16 of the depositing table 4 that the complete third layer is ready there for pushing onto the pallet located therebelow.

If an unplanned stop of the palletizing device 1 occurs, such as, e.g., an emergency stop, for example due to a defect of a bag 200, it is generally difficult for a user to recognize which bag poses the problem and what must be done with this bag.

Depending on the configuration, it can be displayed, which bag 200 causes a problem. Depending on the configuration, however, a user has to also recognize on his own, which bag or which bags 200, respectively, have caused the stop.

According to the invention, it is displayed to a user on the display device 8, however, what he may do with the currently processed bags, or whether or not he may simply remove these bags from the conveying device 2. It is thus suggested by means of the hatching, for example, in the exemplary embodiment shown here, that the bag 5.1.2 must not be removed under any circumstances, at least not without placing a bag at this position again. If this bag were removed without being replaced, there would later be a problem when completing the layer pattern 17 because the subsequent bags cannot simply be conveyed subsequently. Should this bag 200 need to be removed, it has to thus be replaced with a new bag 200. Otherwise, the layer 5 is not completed according to the provided layer pattern 17 and would need to be discarded in its entirety.

It is furthermore illustrated in FIG. 3 that certain bags 200 can be combined to form groups 20, which have to be treated equally. In the shown view, this combination to form a group 20 takes place by means of a highlighting by means of a placement in the background with a hatching in the shown view. However, other markings or highlighting, respectively, can also be used.

It can be seen that the entire third layer is grouped on the depositing table 4 as a unit or group 20, respectively. Should a problem arise here, all bags of the layer would need to be treated equally.

The same applies for the first row of the fourth layer, which already lies on the intermediate storage 22 and which is grouped to form a group 20. The second row of the fourth layer, which is still present on the collecting belt 13, is also combined to form a group 20. It can thus be displayed easily and clearly to a user on the display device 8 by means of the control device 7, how certain bags have to be treated.

Control devices 23, which, depending on the configuration, can each comprise at least one sensor 25, can be provided for automatically recognizing the position or the orientation, respectively, of the bags 200.

In the shown exemplary embodiment, the control devices 23 each comprise a light barrier 26, which can draw a conclusion about the orientation via the time of the activation by a bag 200. A bag lying longitudinally blocks the light barrier longer than a bag in transverse alignment.

It is furthermore illustrated that a trash can symbol is assigned to each station 16 here, so that, e.g., in the case of a display unit 8, which is formed as touch display 15, a user can simply click on a bag 200, which he wants to remove from the system, and can pull it onto the trash can symbol with his finger.

Depending on the configuration, a joint trash can symbol, onto which certain bags can be pulled independently of the station 16, can also be provided, for example centrally on the display device 8.

A further exemplary embodiment of a palletizing device 1 according to the invention or of the display devices 8 of a palletizing device 1 according to the invention, respectively, which essentially corresponds to the exemplary embodiment according to FIG. 3, is illustrated purely schematically in FIG. 4.

In contrast to the exemplary embodiment illustrated in FIG. 3, it is illustrated here that the palletizing device 1 can also have control devices 23, which each comprise at least one camera 27. In the exemplary embodiment shown here, the cameras 27 are illustrated purely schematically, in order to display the detection range.

The cameras 27 in particular serve the purpose of automatically monitoring the conveying process and the palletizing, so that defects on bags can be recognized, for example via an image recognition.

It can further be seen that two handling devices 24 are provided here, which can be moved along the conveyor line here. It can furthermore be seen that these handling devices 24 in the shown exemplary embodiment comprise a pusher 28, which is configured to be extendable here. The handling device 24 of the palletizing device 1 are illustrated on the display device 8, in order to display the position or the state (e.g., pusher 28 retracted or extended).

If a bag is to be removed, for example due to a defect, and if said bag is removed by a user, for example by pulling on the trash can, the handling device 24 can move next to this bag 200 in the exemplary embodiment shown here and can push the bag down from the conveying device 2 by means of the pusher 28. The bag then falls next to the conveying element 3 and can be removed by hand by a user later.

Depending on the configuration, however, the handling device 24 can also comprise a robot or a robot arm, respectively and/or can be provided thereby, which removes the bag 200 and feeds it to a recycling, for example.

Alternatively, a further conveying element for removing defective bags can also be arranged next to the conveyor line, which conveying element removes the bags 200, which the pusher 28 or a robot have conveyed onto this conveying element.

### LIST OF REFERENCE NUMERALS

1 palletizing device
2 conveying device
3 conveying element
4 depositing table
5 rotating device
6 clamping and rotating station
7 control device
8 display device
9 forming device
10 infeed
11 infeed buffer
12 raised infeed situation
13 collecting belt
14 pushing device
15 touch display
16 station
17 layer pattern
18 stud frame
19 gravity roller
20 group
21 ironing and smoothing belt
22 intermediate storage
23 control device
24 handling device
25 sensor
26 light barrier
27 camera
28 pusher
100 piece goods
200 bag
300 pallet
400 packaging facility

1. A method for operating a palletizing device for palletizing piece goods wherein the palletizing device comprises at least one conveying device with at least one conveying element for conveying piece goods and at least one depositing table,
wherein the conveying device comprises at least one rotating device for rotating the piece goods,
wherein the palletizing device has at least one control device and at least one display device, comprising:
it is displayed to a user on the display device in the response to a stop of the palletizing device, after an unplanned stop, which piece goods may/must be removed from the process and/or which piece goods may/must not be removed from the process.

2. The method according to claim 1, wherein the piece goods currently located on the palletizing device is displayed graphically to the user.

3. The method according to claim 1, wherein depending on whether or not they may be removed from the process, piece goods are displayed at least with a property, which is displayable differently.

4. The method according to claim 1, wherein the piece goods are identified according to a predetermined later position in a layer pattern.

5. The method according to claim 1, wherein the user deletes at least one piece of piece goods in the display device, wherein the control device adapts the processing of the subsequent piece goods accordingly.

6. The method according to claim 1, wherein the user marks and deletes the corresponding piece goods in order to delete piece goods.

7. The method according to claim 1, wherein a warning is output when piece goods, which must not be removed from the process, are to be deleted.

8. The method according to claim 7, wherein the deleted piece goods are removed manually, semi-automatically and/or automatically from the process.

9. The method according to claim 1, wherein the palletizing device is divided into different stations and that the handling of the piece goods of the individual stations is evaluated and/or displayed separately.

10. The method according to claim 1, wherein several bags are displayed so as to be combined to form a group, which have to be treated equally.

11. The method according to claim 10, wherein the user (marks and) deletes at least one group of piece goods in the display device and that the control device adapts the processing of subsequent piece goods accordingly.

12. The method according to claim 4, wherein the planned layer patterns for the currently processed piece goods are displayed.

13. The method according to claim 1, wherein at least one control device is provided, which is suitable and formed to check the orientation and/or the state of the piece goods.

14. The method according to claim 13, wherein the control device checks after a removal of piece goods, whether the deletion of piece goods corresponds to the removal of piece goods.

15. A palletizing device for palletizing piece goods, wherein the palletizing device comprises: at least one conveying device with at least one conveying element for conveying piece goods and at least one depositing table and wherein the conveying device comprises at least one rotating device for rotating the piece goods;
and wherein the palletizing device comprises at least one control device and at least one display device; and
the control device is suitable and formed to carry out the method according to claim 1.

16. The palletizing device according to claim 15, wherein the display device comprises at least one touch display.

17. The palletizing device according to claim 16, wherein at least one handling device is provided for removing piece goods.
